(19) United States
(12) Patent Application Publication
(10) Pub. No.: US 2017/0113548 A1
(43) Pub. Date: Apr. 27, 2017

(54) USER INTERFACE FOR AN AGRICULTURAL SYSTEM

(71) Applicant: CNH Industrial America LLC, New Holland, PA (US)

(72) Inventors: Natalia Lucas, Mundelein, IL (US); Bushra Ali, Bensenville, IL (US); John Stratton, Denver, CO (US)

(73) Assignee: CNH Industrial America LLC, New Holland, PA (US)

(21) Appl. No.: 14/923,605

(22) Filed: Oct. 27, 2015

(51) Int. Cl. B60K 35/00; G06F 3/0481; G06F 3/0484; A01B 76/00

(52) U.S. Cl. CPC B60K 35/00; A01B 76/00; G06F 3/0481; G06F 3/04842; B60K 2350/1004; B60K 2350/108; B60K 2350/352

(57) ABSTRACT

An agricultural system including a vehicle, a controller and a display mounted in the vehicle, and an implement coupled to the vehicle. The display is coupled to the controller, and the controller is configured to: identify a system configuration of the vehicle; identify a system configuration of the implement; load and render on the display a selected user interface dependent upon the system configuration of the vehicle and the system configuration of the implement; and provide a tutorial mode with navigational aids to complete setup data for the agricultural system relative to the system configuration of the vehicle and the system configuration of the implement.

### BACKGROUND OF THE INVENTION

1. Field of the Invention

The present invention relates to an agricultural control system, and, more particularly, to a display regime for presenting a selected user interface associated with the configuration of the agricultural system.

2. Description of the Related Art

Modern farming practices have developed to improve the speed and efficiency of the farm equipment used to plant, maintain, and harvest crops. For example, tractors include a global positioning system (GPS) and a controller in the tractor is configured to provide a topographical view of a field and to identify the location of the tractor within the field based on the GPS coordinates. In addition, multiple agricultural implements may be connected to the tractor. During planting, for example, the tractor may pull an air cart having multiple containers including one or more types of seed and/or fertilizer. The tractor may also pull a planter to plant the seeds.

The controller on the tractor may be configured to control operation of the implements connected to the tractor. Different models of each implement may include varying operating parameters such as capacity, rate of application, or number of rows. The operating parameters may also depend, for example, on the configuration or operating characteristics of the tractor or the location within the field. Each of the operating parameters needs to be configured prior to operation of the respective implement. Consequently, each implement typically includes a configuration module stored on the controller of the tractor to configure operation of the respective implement.

However, as the number of features on the agricultural implements increase so does the number of operating parameters and the complexity of configuring operation of the tractor and the connected implements. In addition, different implements such as the air cart and planter may interact with each other. Changing the configuration of a parameter on one of the implements may impact operation of the other implement.

In a known type of planting implement, seed planting or row units are attached to a toolbar extending transverse to the direction of planting. The toolbar is coupled to a tractor or other work vehicle suitable for pulling the planting implement along a field that is to be seeded to a crop. Each planting unit includes a ground penetrating assembly, often including one or more discs, for opening a seed trench or furrow in the ground as the planting implement is pulled across a field. Components of the ground penetrating assembly shape the bottom and sides of the seed trench, and a seed-metering device provides individual seeds at a controlled rate for deposit in the seed trench. Furrow closing components of each row unit close the seed trench in a controlled manner.

Agricultural planters are commonly used implements to plant seeds in soil. An agricultural planter can include a chassis that carries one or more storage tanks carrying seed, and chemical applications that are to be applied to the field during the planting operation, a hitch mechanism that attaches to a tractor or other implement pulled by a tractor, and a tool bar that row units can be connected to so they are carried by the chassis. The planter can also include a pneumatic system carried by the chassis that supplies pressurized air to transport the seeds or other particulate from the storage tanks to the row units.

Each row unit of the agricultural planter places seeds in the field. By having multiple row units working in unison as the planter is pulled across a field, many seeds can be effectively planted in an efficient manner.

The modern farmer faces the challenge of integrating many kinds of equipment starting with the vehicle itself, which can be coupled to all kinds of implements (planters, sprayers, seeders, tillage equipment etc.), and have various navigational controllers and high precision GPS receivers installed. These all lead to very complex setups and a large amount of data.

Since a variety of tractors can couple to a variety of implements, such as a planter, the capabilities of the controls and availability of information relative to the operation of the implement/vehicle system creates a problem of adequate displays of information and presentation of controls to a user. The amount of setups that a user has to go through on agricultural equipment may be overwhelming.

What is needed in the art is a robust system that detects the agricultural system configurations and leads to a selected display of the needed setup and selections in an intuitive and efficient manner.

### SUMMARY OF THE INVENTION

The present invention provides a user interface related to a particular combined configuration of an agricultural vehicle and an associated implement.

The invention in one form is directed to an agricultural system including a vehicle, a controller and a display mounted in the vehicle, and an implement coupled to the vehicle. The display is coupled to the controller, and the controller is configured to: identify a system configuration of the vehicle; identify a system configuration of the implement; load and render on the display a selected user interface dependent upon the system configuration of the vehicle and the system configuration of the implement; and provide a tutorial mode with navigational aids to complete setup data for the agricultural system relative to the system configuration of the vehicle and the system configuration of the implement.

The invention in yet another form is directed to a method of displaying information for an agricultural system that includes a vehicle, an implement coupled to the vehicle, a controller and a display mounted in the vehicle. The display is coupled to the controller. The method includes the steps of: identifying a system configuration of the vehicle; identifying a system configuration of the implement; loading and rendering on the display a selected user interface dependent upon the system configuration of the vehicle and the system configuration of the implement; and providing a tutorial mode with navigational aids to complete setup data for the agricultural system relative to the system configuration of the vehicle and the system configuration of the implement.

An advantage of the present invention is that it leads the user through the need setup of the agricultural system.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic representation of a complete agricultural system using an embodiment of a user interface method of the present invention for rendering on a display;

FIG. 2 is a depiction of an implement of FIG. 1 that is coupled to the tractor and subject to the configuration selections made on the display of the present invention;

FIG. 3 is a depiction of a display of a runscreen illustrating performance details of the tractor and implement of FIGS. 1 and 2;

FIG. 4 is a depiction of a menu selected setup display for an implement on a menue screen with performance information of the planter implement of FIGS. 1 and 2 on the left hand area; and

FIG. 5 illustrates a screen showing some information of the performance of the tractor of the agricultural system of FIG. 1.

Corresponding reference characters indicate corresponding parts throughout the several views. The exemplification set out herein illustrates one embodiment of the invention, in one form, and such exemplification is not to be construed as limiting the scope of the invention in any manner.

### DETAILED DESCRIPTION OF THE INVENTION

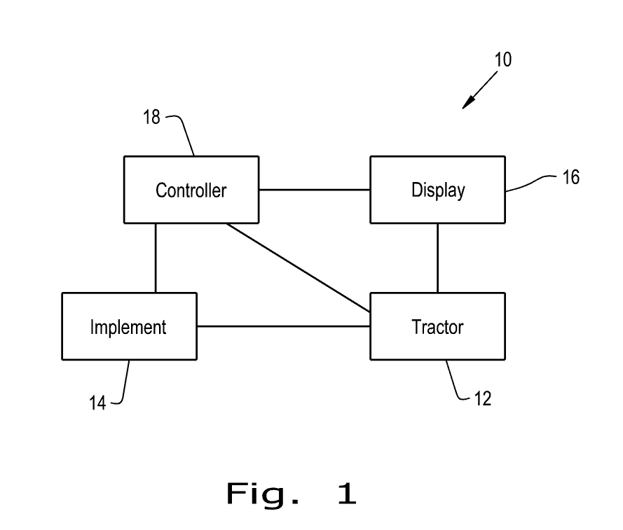

Referring now to the drawings, and more particularly to FIG. 1, there is shown an embodiment of an agricultural system 10 having a tractor 12, an implement 14 and a display 16 that is incorporated in tractor 12. Display 16 is an interactive display 16 configured to provide information to a user and allow the user to direct the operation of tractor 12 and/or implement 14. A controller 18 receives information from sensors on implement 14 and tractor 12, processes, stores and displays selected portions of that information and other stored information such as setup information and configuration selections. The displaying of information and control features on display 16 takes into account needed setup and configuration aspects of the agricultural system 10.

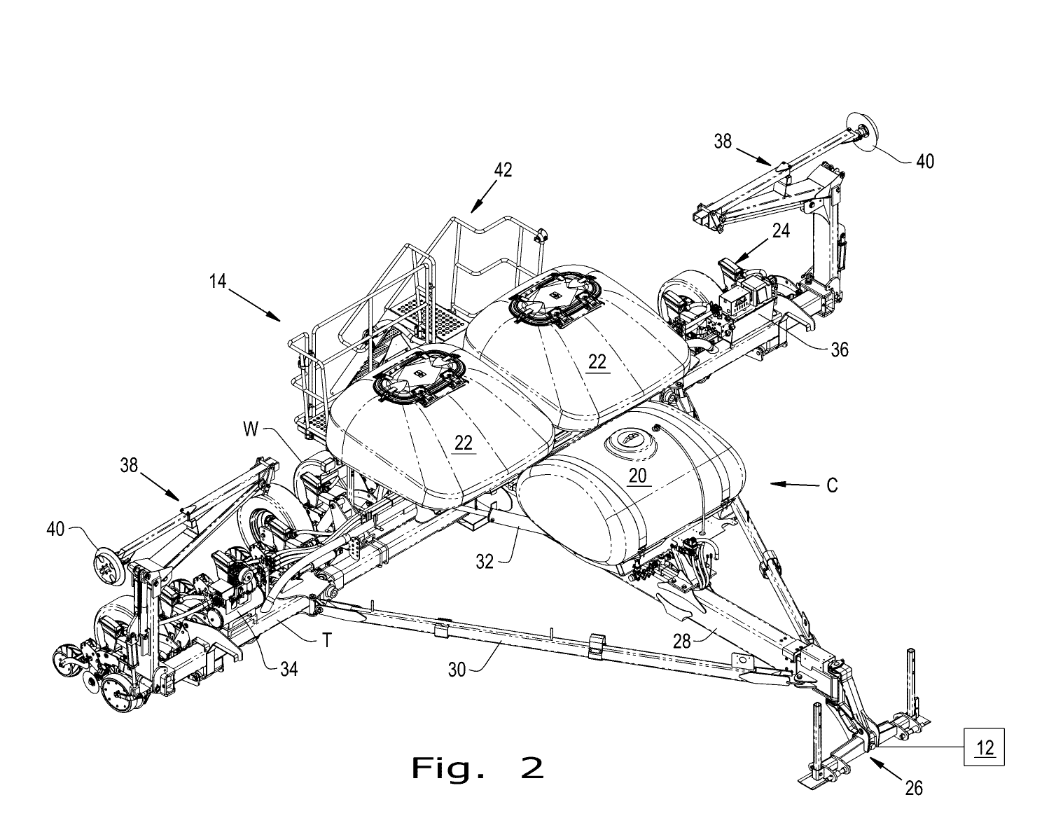

Now, additionally referring to FIG. 2, there is shown some details of a typical implement 14 in the form an agricultural planter 14 which generally includes a chassis C forming a support structure for components of the planter 14 that can be formed by a hitch assembly at a front of the planter 14 connected to a tool bar T, main wheels W carried by the chassis near a rear of the planter 14, one or more storage tanks 20 and 22 that can be filled with seed or other agriculture material carried by the chassis, and a plurality of row units 24 connected to the tool bar T and arranged laterally across a length of the tool bar T so that they are carried by the chassis. The chassis C can include a hitch 26 configured to be connected to a tractor 12 or other agricultural implement (not shown) so that the planter 14 can be pulled in a forward direction of travel. The hitch 26 can be integrally formed with or connected to a hitch bar 28 that is connected to the tool bar T by bracing bars 30 and one or more cylinders 32. As can be seen, the planter 14 can also have various hydraulic, pneumatic, and electrical lines (unnumbered) throughout to support various cylinders and systems that are included on the planter 14, such as a pneumatic system 34 connected to the tool bar T and an electric generator 36 also connected to the tool bar T. A marking device 38 can be connected to each lateral end of the tool bar T and extendable so that a marking disc 40 of the marking device 38 can create a line in the soil as the planter 14 is pulled that helps a user in positioning the planter 14 to create subsequent rows. A stair assembly 42 can be mounted to the back of the planter 14 to allow for an operator to access the storage tanks 22.

While a planter 14 is shown in detail it is to be understood that any agricultural implement 14 can be utilized. Further, although a towing of implement 14 by tractor 12 is illustrated herein it should be understood that tractor 12 may be any agricultural, construction, or forestry vehicle that can be coupled to various implements 14.

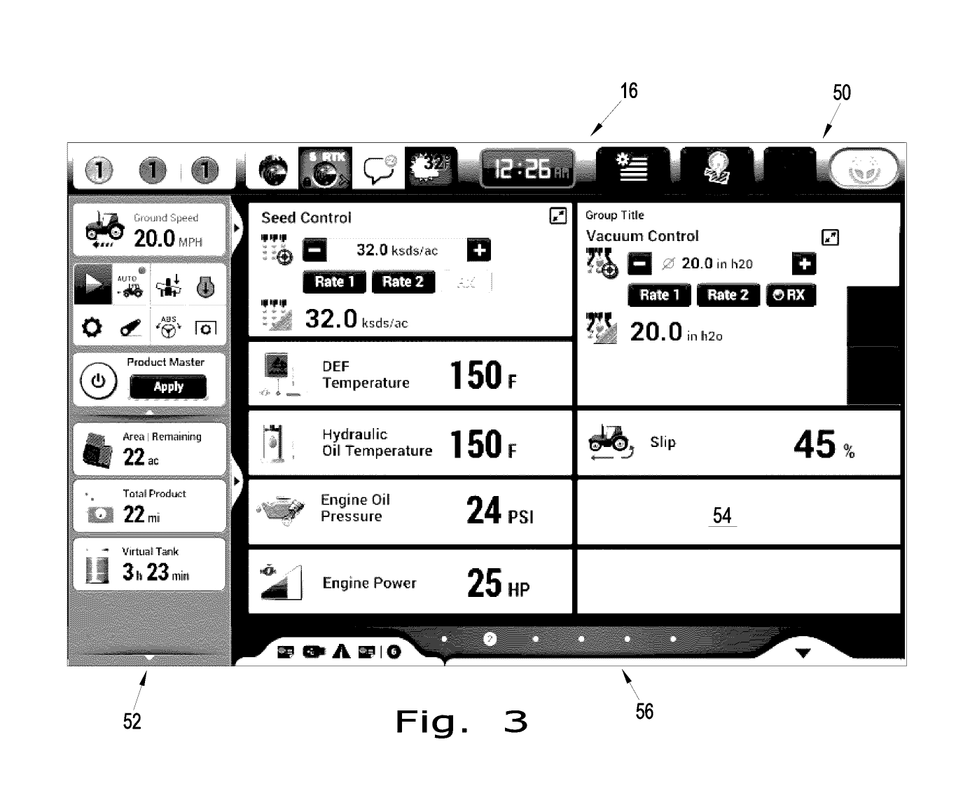

Now, additionally referring to FIG. 3, there is shown a screen rendering of operating details selected by the user relative to elements of tractor 12 and for implement 14. For example, the seed control of planter 14 and the vacuum performance of planter 14 is illustrated as well as the DEF temperature of tractor 12. A use of a Phoenix (12 inch) or of a Hawk (8 inch) display 16 is contemplated and a User Experience (UX) framework is designed to consistently display navigational items and provide user customizable areas for equipment controls and feedback.

The Phoenix Display is divided into several distinct screen regions: a Top Bar 50, a Left Hand Area 52, a Runscreen 54, a Bottom Bar 56, and a Menu 58 with a Settings Screen, a Diagnostics Screen, a Productivity Screen, and a Tutorial Mode selection.

The Top Bar 50—Provides access to global level information, tools, and setups. The Top Bar 50 is shown all the time, is never covered by popups, and includes fault lamps, status, Global Navigation Satellite System (GNSS) and Guidance statuses, as well as access to the Menu 58 and the Home Screen.

The Left Hand Area 52 (LHA)—Contains vehicle status and performance data; with views and controls needed as the operator drives and bounces through the field. The LHA 52 is shown all the time to the user, and is never covered by popups. The upper portion is dedicated to vehicle 12. The upper portion can show either regulatory or platform requirements. This portion is not changeable by the user. The lower portion is changeable by the user, with default displays provided. The expandable drawers show additional info when selected by the operator, just one touch away from the runscreen 54.

The Runscreen 54—Contains controls that users need daily in order to efficiently operate the equipment 10 and productively accomplish the job. The Runscreen 54 has views and controls you needed to drive in the field, for example, Target rate control, a planter bar graph, Combine ACS engage, and loss monitors. Layouts of the Runscreen 54 are changeable by the user, with defaults being provided.

The Bottom Bar 56—Contains runscreen 54 page controls, status and shortcuts drawers. These are shown all the time, are never covered by popups; and includes fault lamps, status, GNSS and Guidance statuses, access to Menu 58 and Home Screens. The regions help to organize the data and provide the user with a system for understanding where certain types of data, controls, or interactions are available. A particularly distinctive feature is the way the data is organized, with all the setups that are done once in a while being stored under the menu 58 (accessed through Top Bar 50).

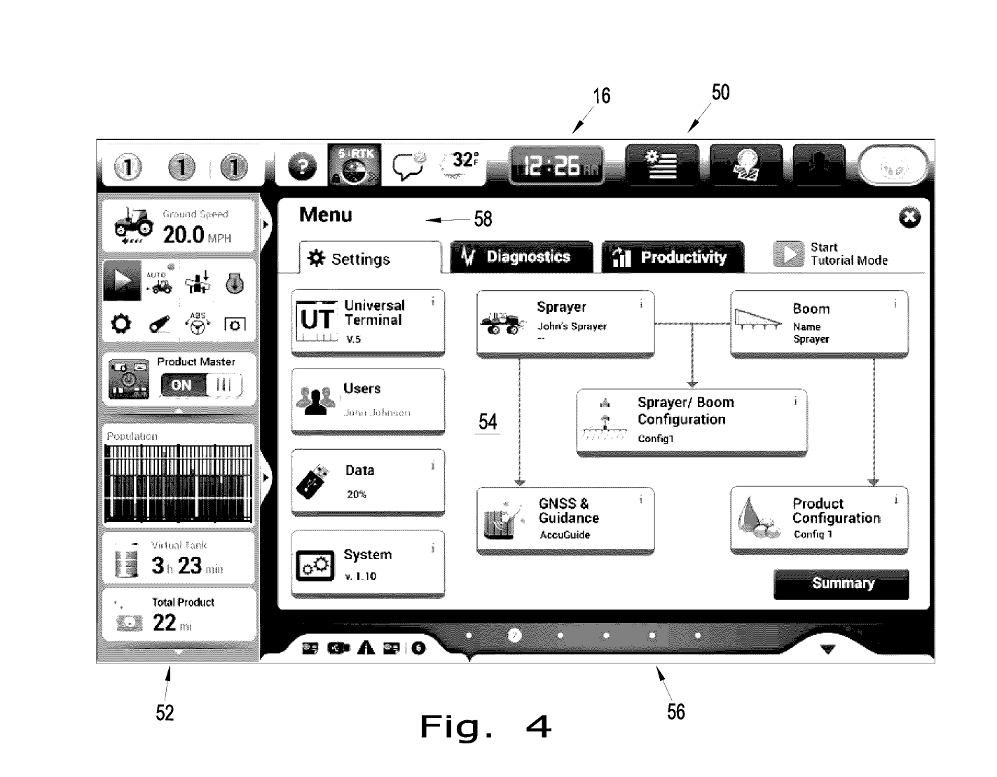

Now, additionally referring to FIG. 4, the Menu 58—Settings Screen: is for first-time setup or major operational changes throughout the season. These settings include calibrations, vehicle measurements, control modes and ranges, as well as calibration values.

The Menu 58—Productivity Screen: is for summary reports to the user at the end of an operation. The reports are based on a certain Field/Task or on a user-resettable counter related to an event that is counted. The reports can contain both vehicle 12 and implement 14 information.

The Menu 58—Diagnostics Screen: is for detailed diagnostics when an operator or a dealer needs to investigate a problem. This can also be used for special case operations (stationary manual testing to make sure hardware is working, etc.). All the setups that the user needs for daily operations are stored under the Home Screen (accessed through the Top Bar 50), such as a Grower/Farm/Field/Crop/Task selection and the ask management of the Vehicle/Implement/Vehicle and Implement Configuration/Product Configuration overview—Product assignment—Variety Tracking etc.

All of the status (Read-Only) as well as adjustments that the user needs immediately as they are driving through the field are placed on the Runscreen 54 and LHA 52, which are user customizable. Another notable characteristic is the scalability between the 12 inch (Phoenix) and 8 inch (Hawk) Displays 16 providing a consistent User Interface (UI)/User Experience (UX). The UI/UX framework supports dual display navigation with any variation of Phoenix and Hawk displays. The UI/UX framework is highly flexible supporting the movement of display 16/controller 18 from one vehicle to another including non-CNHi vehicles.

The Phoenix and Hawk Displays are installed in the tractors 12, on boot, the display 16 will identify the system configuration (i.e. vehicle make and model, implement make and model, software unlocks etc.) and will load and render that specific UI. Additionally a tutorial mode filled with navigational tips is available on the rendering. Then the user will have to setup the system, and going with the defaults is one of the choices.

The bottom LHA 52 and Runscreen 54 are loaded with a default set of data and controls which the user can change at any time by way of an Edit Mode. Each set of vehicle 12/implement 14 pairings have preloaded defaults appropriate for a specific selected operation.

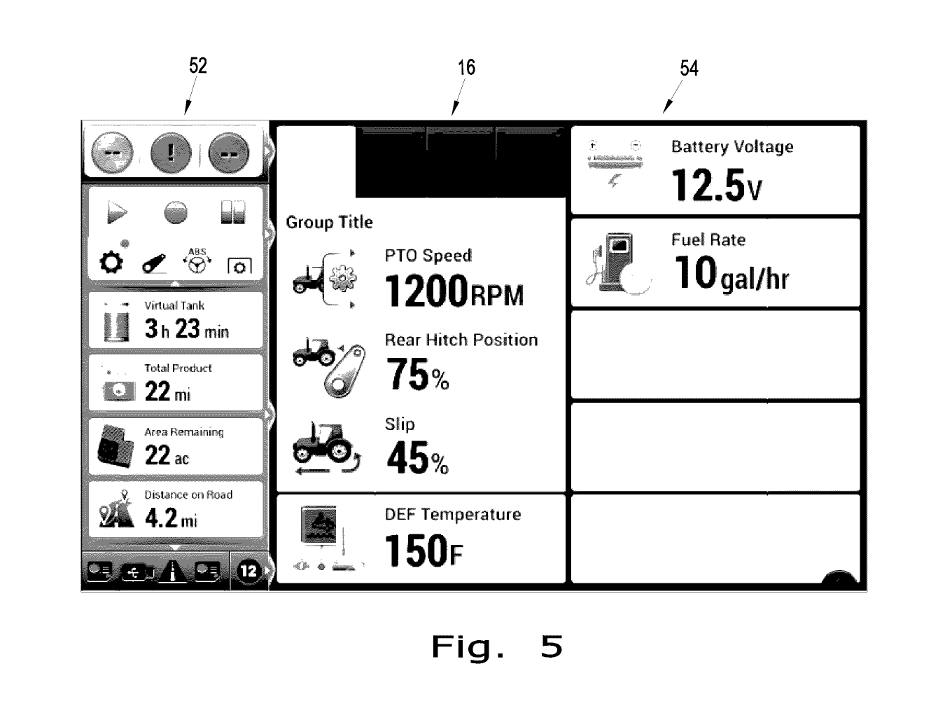

Now, additionally referring to FIG. 5, there is illustrated an information/selection screen that shows the operation of some elements of tractor 12 in the Runscreen 54, with some productivity elements in the LHA 52. This display 16 may be an alternate display 16.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural system, comprising:
a vehicle;
an implement coupled to said vehicle;
a controller; and
a display mounted in said vehicle, said display being coupled to said controller, said controller being configured to:
identify a system configuration of said vehicle;
identify a system configuration of said implement;
load and render on said display a selected user interface dependent upon said system configuration of said vehicle and said system configuration of said implement; and
provide a tutorial mode with navigational aids to complete setup data for the agricultural system relative to said system configuration of said vehicle and said system configuration of said implement.

2. The agricultural system of claim 1, wherein said controller is further configured to identify said system configuration of said vehicle and to identify said system configuration of said implement upon being booted.

3. The agricultural system of claim 2, wherein said controller is further configured to render said selected user interface upon a variety of types of said display.

4. The agricultural system of claim 2, wherein said system configuration of said vehicle includes a vehicle make and model of said vehicle, and said system configuration of said implement includes an implement make and model of said implement.

5. The agricultural system of claim 4, wherein said system configuration of said vehicle and said system configuration of said implement further include software unlocks associated with said vehicle and/or said implement.

6. The agricultural system of claim 1, wherein default settings are provided as part of the setup data.

7. A method of displaying information for an agricultural system that includes a vehicle, an implement coupled to the vehicle, a controller and a display mounted in the vehicle, the display is coupled to the controller, the method comprising the steps of:
identifying a system configuration of the vehicle;
identifying a system configuration of the implement;
loading and rendering on the display a selected user interface dependent upon said system configuration of said vehicle and said system configuration of said implement; and
providing a tutorial mode with navigational aids to complete setup data for the agricultural system relative to said system configuration of said vehicle and said system configuration of said implement.

8. The method of claim 7, wherein said identifying said system configuration of said vehicle and said identifying said system configuration of said implement take place immediately following a booting of the controller.

9. The method of claim 8, further comprising the step of rendering said selected user interface upon a selected one of a variety of types of said display.

10. The method of claim 8, wherein said system configuration of said vehicle includes a vehicle make and model of said vehicle, and said system configuration of said implement includes an implement make and model of said implement.

11. The method of claim 10, wherein said system configuration of said vehicle and said system configuration of said implement further include software unlocks associated with said vehicle and/or said implement.

12. The method of claim 7, wherein default settings are provided as part of the setup data.
